(19) United States
(12) Patent Application Publication
(10) Pub. No.: US 2013/0307824 A1
(43) Pub. Date: Nov. 21, 2013

(54) CONTROLLER ARRANGEMENT CONFIGURED TO REMOTELY CONTROL AN ELECTRONIC DEVICE

(71) Applicants: Hoong Yih Chan, Singapore (SG); Cheoung Hong Lee, Singapore (SG); Peilin Phui, Singapore (SG)

(72) Inventors: Hoong Yih Chan, Singapore (SG); Cheoung Hong Lee, Singapore (SG); Peilin Phui, Singapore (SG)

(21) Appl. No.: 13/982,303

(22) PCT Filed: Jan. 28, 2011
(86) PCT No.: PCT/SG2011/000040

§ 371 Date: Jul. 29, 2013

(51) Int. Cl. G06F 3/045

(52) U.S. Cl. CPC G06F 3/045
USPC 345/174

(57) ABSTRACT

A controller configuration is configured to remotely control an electronic device. The controller configuration includes a support substrate, a driver configured to drive the controller configuration and an antenna configured to allow the controller configuration to communicate with the electronic device. The controller configuration further has a touch panel configured to allow tracking of a finger movement based on a resistance change and a processor configured to generate a corresponding control signal based on tracking of the finger movement so as to remotely control the electronic device. The driver, the antenna, the touch panel and the processor may be monolithically integrated in or on the support substrate. An electronic system including a controller configuration may also be provided.

Embodiments relate to a controller arrangement or a remote control unit (RCU) configured to remotely control an electronic device with one or more combined functionalities, for example a device with hearing aid support, entertainment electronics, telecommunication.

Generally, a pocket size handheld remote control unit has a few disadvantages. The remote control unit generally adds bulk to the pocket or bag of a user. Further, it may be difficult and cumbersome for the user to rummage through the pocket or bag to retrieve the remote control unit since the user usually carries a wide range of items in the pocket or bag, for example mobile phone, car key, MP3 player, coin pouch, wallet. In addition, the push buttons as the user control on the remote control unit may restrict the size of the remote control unit. For example, if the push button is too small, the user may have difficulties to access the control on the remote control unit. There may also be a chance that the user may misplace the remote control unit easily. Even further, as an example for a hearing aid user, the high visibility of the remote control unit may draw unwanted attention to the user who may prefer to be more discreet about the user's hearing problem.

Therefore, in various embodiments, a controller arrangement or a remote control unit may be provided, which takes into account the following concerns of the known remote control unit and introduces an alternative way of how the remote control unit is being carried and handled. The various embodiments introduce a wearable remote control unit which may allow the user to hide the remote control unit anywhere for example under the clothes, thereby providing maximum invisibility, flexibility and accessibility.

An embodiment relates to a controller arrangement or a remote control unit configured to remotely control an electronic device. The controller arrangement may include a support substrate; a driver configured to drive the controller arrangement; an antenna configured to allow the controller arrangement to communicate with the electronic device; a touch panel configured to allow tracking of a finger movement based on a resistance change; and a processor configured to generate a corresponding control signal based on tracking of the finger movement so as to remotely control the electronic device; wherein the driver, the antenna, the touch panel and the processor may be monolithically integrated in or on the support substrate.

In an embodiment, having the respective driver, the antenna, the touch panel and the processor monolithically integrated in or on the support substrate may mean that the respective driver, the antenna, the touch panel and the processor may be manufactured into or on top of a single support substrate, a semiconductor substrate or a chip. In this regard, a fully monolithically integrated controller arrangement may be advantageous to minimize form factor, reduce cost and ease mass production.

In an embodiment, the support substrate may include a flexible printed circuit board (PCB). The support substrate may be configured to have a certain rigidity so as to provide sufficient support for the components arranged thereon and yet being flexible enough to accommodate the placement of the controller arrangement onto any suitable surface. Further, the support substrate may also be sized so as to accommodate the placement of the other components thereon.

In an embodiment, the driver may include a battery or an energy buffer driven by an external driving source. The battery may include a rechargeable micro battery, for example a lithium polymer battery. The lithium polymer battery may be as small as about 3 mm in thickness and may weigh less than 10 g, thus reducing the bulk and weight of the controller arrangement. However, any other suitable battery may also be used.

In an embodiment, the energy buffer may allow a conversion of an′ original direct current (DC) source to—a desirable level and form in order to drive the controller arrangement. The energy buffer may have a few functions, for example, act as a buffer for ripple current, sink for reactive/regenerative power, storage for over-produced power, provide overload/peak current and provide warm up power. Some examples of the energy buffer may include a supercapacitor or a gold capacitor.

In an embodiment, the energy buffer may be driven by the external driving source via a direct energy transfer or a remote energy transfer.

In an embodiment, the direct energy transfer may include a wired connection. For example, the energy buffer may be charged via wires first before being used to drive the electronic device.

In an embodiment, the remote energy transfer may include wireless energy transfer or any other suitable methods. Wireless energy transfer is the transmission of electrical energy from a power source to an electrical load without interconnecting wires. Wireless energy transfer is useful in cases where interconnecting wires are inconvenient, hazardous, or impossible. Some examples of the remote energy transfer may include inductive coupling followed by resonant inductive coupling, microwaves and lasers.

In J an embodiment, the antenna may be laminated or printed directly on the support substrate, for example a printed antenna strip. In this regard, the antenna may be printed on the support substrate using any suitable printing techniques such as screen-printing for example. The printed antenna on the support substrate may reduce the thickness of the controller arrangement, which may make it easier for the user to hide the controller arrangement under the clothes. Other possible examples for the antenna may include an inductive coil of less than 10 mm in length.

In an embodiment, the touch panel with the resistive sensor may eliminate the need of mechanical user controls such as buttons, thereby reducing the size of controller arrangement. The resistive sensor may allow the user to control the controller arrangement with a simple touch/motion and therefore the size of the user control may not be constrained.

In an embodiment, the touch panel may be configured to include a set of two-dimensional co-ordinates (that is X, Y co-ordinates) to allow tracking of the finger movement.

In an embodiment, the finger movement may be selected from a group of finger movements consisting of an upward finger sweeping motion, a downward finger sweeping motion and a tapping finger motion. The upward finger sweeping motion may imply an increase in volume, the downward finger sweeping motion may imply a decrease in volume, and the tapping finger motion may imply a change of program. However, this relation between the finger motion and the control of the controller arrangement may vary depending on user and design requirements.

In an embodiment, the controller arrangement may be dimensioned to include a thickness of about 1 mm or less.

In an embodiment, the controller arrangement may further include at least one attachment member configured for attachment to a user. The at least one attachment member may be positioned on any suitable position on the support substrate. The number, size and configuration of the at least one attachment member may vary depending on user and design requirements. As an example, for attachment to a piece of clothing, for example a shirt, the at least one attachment member may include a spring clip, an annular clamp, a velcro strip, an adhesive, a suction cup or the like.

An embodiment may provide for an electronic system. The electronic system may include an electronic device; and a controller arrangement configured to remotely control the electronic device. The controller arrangement may include a support substrate; a driver configured to drive the controller arrangement; an antenna configured to allow the controller arrangement to communicate with the electronic device; a touch panel configured to allow tracking of a finger movement based on a resistance change; and a processor configured to generate a corresponding control signal based on tracking of the finger movement so as to remotely control the electronic device; wherein the driver, the antenna, the touch panel and the processor may be monolithically integrated in or on the support substrate.

In an embodiment, the controller arrangement may be configured to remotely control the electronic device via a wireless communication selected from a group of wireless communications consisting of radio frequency communication, microwave communication, bluetooth communication and infrared short range communication.

In an embodiment, the electronic device may include a hearing aid or a communication device. Further, the electronic device may also include one or more combined functionalities, for example a device with hearing aid support, entertainment electronics and telecommunication.

In the drawings, like reference characters generally refer to the same parts throughout the different views. The drawings are not necessarily to scale, emphasis instead generally being placed upon illustrating the principles of various embodiments. In the following description, various embodiments are described with reference to the following drawings, in which:

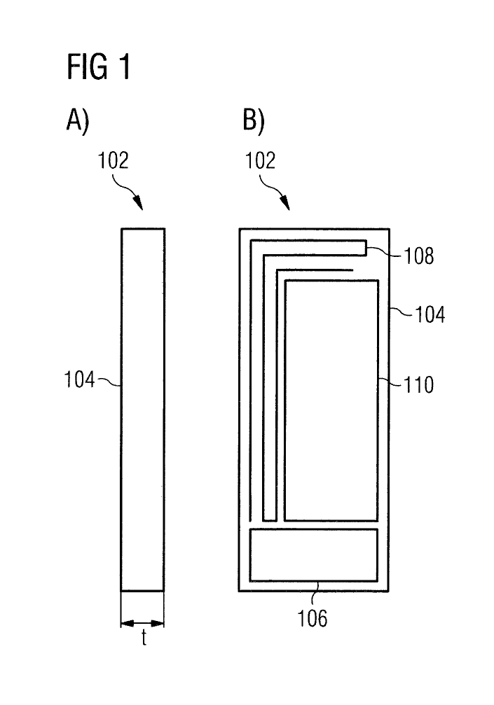

FIGS. 1A and IB show respective side view and top view of a controller arrangement according to an embodiment;

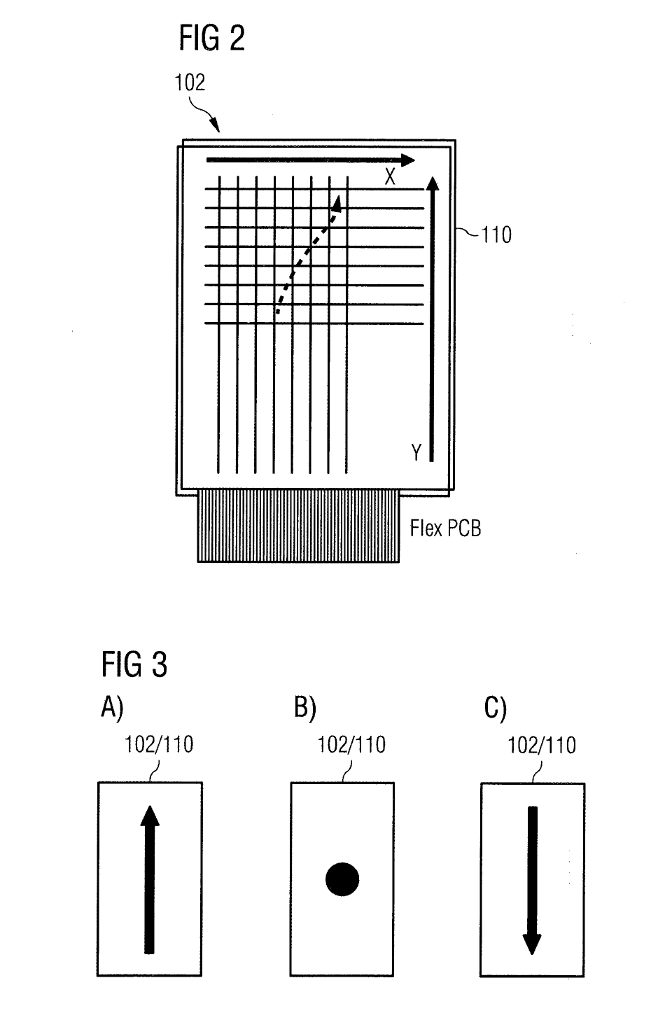

FIG. 2 shows a detailed front view of a touch panel of the controller arrangement as shown in FIGS. 1A and IB according to an embodiment;

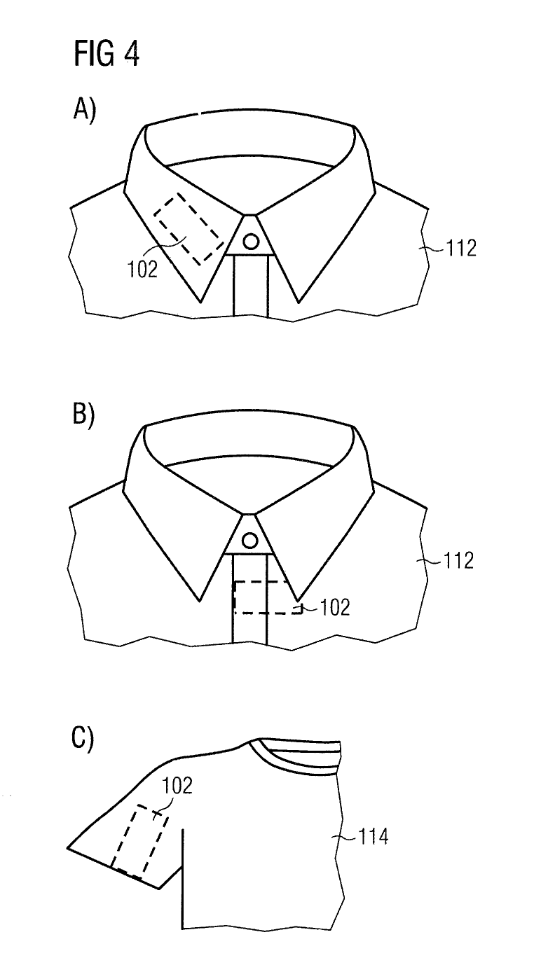

FIGS. 3A to 3C show respective controls of an electronic device by using different finger motions on a touch panel of a controller arrangement according to an embodiment; and

FIGS. 4A to 4C show different examples of how a user can carry a controller arrangement according to an embodiment.

FIGS. 1A and IB show respective side view and top view of a controller arrangement 102 according to an embodiment.

The controller arrangement 102 may be configured to remotely control an electronic device (not shown). The controller arrangement 102 may include a support substrate 104; a driver 106 configured to drive the controller arrangement 102; an antenna 108 configured to allow the controller arrangement 102 to communicate with the electronic device; a touch panel 110 configured to allow tracking of a finger movement based on a resistance change; and a processor (not shown) configured to generate a corresponding control signal based on tracking of the finger movement so as to remotely control the electronic device; wherein the driver 106, the antenna 108, the touch panel 110 and the processor may be monolithically integrated in or on the support substrate 104.

In an embodiment, the support substrate 104 may include a flexible printed circuit board or any other suitable substrate as long as the components may be monolithically integrated thereon and/or therein. The support substrate 104 may also be configured to have a certain rigidity so as to provide sufficient support for the components arranged thereon and yet being flexible enough to accommodate the placement of the controller arrangement 102 onto any suitably surface. Further, the support substrate 104 may also be sized so as to accommodate the placement of the other components thereon.

In an embodiment, the driver 106 may include a battery or an energy buffer driven by an external driving source (not shown). The battery may include a rechargeable micro battery, for example a lithium polymer battery. The lithium polymer battery may be as small as about 3 mm in thickness and may weigh less than about 10 g, thus reducing the bulk and weight of the controller arrangement 102. However, any other suitable battery may also be used.

In an embodiment, the energy buffer may include a supercapacitor or a gold capacitor depending on user and design requirements. The energy buffer may be driven by the external driving source via a direct energy transfer or a remote energy transfer. The direct energy transfer may include a wired connection. For example, the energy buffer may be charged via wires first before being used to drive the electronic device. The remote energy transfer may include an inductive coupling or any other suitable coupling.

In an embodiment, the antenna 108 or traces may be printed directly on the support substrate 104 by any suitable printing techniques. Alternatively, the antenna 108 may be laminated on a surface of the support substrate 104 or, in′ some cases, the antenna 108 may occupy several layers of a multilayer board and vias may be used to interconnect the respective antenna 108 or traces on each layer. The antenna 108 may be of any suitable design or pattern depending on the design and user requirements. The purpose of the antenna 108 on the support substrate 104 may be to provide a method of wireless communication.

From the side view as shown in FIG. 1A, the controller arrangement 102 may be seen to include a thickness (indicated by “t”) of about 1 mm or less. The thickness of the controller arrangement 102 may vary depending on user and design requirements.

Also, the processor may be positioned adjacent to the driver 106.

FIG. 2 shows a detailed front view of a touch panel 110 of the controller arrangement 102 as shown in FIGS. 1A and IB according to an embodiment.

The touch panel 110 or touch-screen monitor may be a resistive system which may include three basic components or layers that may be used to recognize a person's touch. The three basic components or layers may include a normal glass panel that is covered with a conductive layer and a resistive metallic layer.

The respective conductive layer and the resistive metallic layer are held apart by spacers, and a scratch-resistant layer is placed on top of the whole setup. An electrical current may run through the respective conductive layer and the resistive metallic layer while the touch panel 110 or touch-screen monitor may be operational.

When a user touches the touch panel 110 or touch-screen monitor, the respective conductive layer and the resistive metallic layer make contact in that exact spot. The change in the electrical field may be noted and the coordinates (X,Y) of the point of contact may be calculated by a micro-computer or processor (not shown) positioned within the controller arrangement 102 or outside of the controller arrangement 102. Once the coordinates (X, Y) are known, a special driver may translate the touch into something that the micro-computer may understand.

In this regard, the finger movement may be traced by the coordinate system like a computer mouse and may determine direction of movement by the micro-computer connected to touch panel 110 or touch-screen monitor via a support substrate 104 or a flex PCB. Software script may be written to interpret the movement into a remote control command by an end user and send to a remote electronic device, for example a hearing aid positioned on the ear.

As an example, an upward finger sweeping motion across increasing X-Y co-ordinates may be shown by a dotted arrow in FIG. 2. This may indicate an increase in volume of the electronic device as also indicated later in′ the description relating to FIG. 3A.

FIGS. 3A to 3C show respective controls of an electronic device by using different finger motions on a touch panel 110 of a controller arrangement 102 according to an embodiment.

As an example, three different finger movements may be shown in FIGS. 3A to 3C. However, this relation between the respective finger motion and the control of the controller arrangement 102 may vary depending on user and design requirements.

FIG. 3A shows an upward finger sweeping motion represented by an upward arrow on the touch panel 110. The upward finger sweeping motion may correlate to an increase in volume in the electronic device. The extent of the increase in volume may be controlled by how far the finger moves upwardly along the touch panel 110. The further the finger moves upwardly along the touch panel 110, the higher the increase in volume. The upward finger sweeping motion may start at any position on the touch panel 110 as long as there may be sufficient space for the finger to move upwardly. Should the upward finger sweeping motion start at a position towards the upper end of the touch panel 110, the user may then repeat this upward finger sweeping motion so as to obtain the desired increase in volume. Further, the upward finger sweeping motion may not necessarily be in a vertical upward direction substantially along a fixed X-co-ordinate. The upward finger sweeping motion may also be at an angle or any other pattern as long as the upward finger sweeping motion may be directed upwards (or . the X-co-ordinate and the Y-co-ordinate may be increasing).

FIG. 3B shows a tapping finger motion represented by a dot on the touch panel 110. The tapping finger motion may imply a change of program and the user may continue to tap on the touch panel 110 until the desired program may be selected. The tapping finger motion may be done on any suitable position on the touch panel 110. The number and frequency of taps may be programmed according to a user's preference and needs.

FIG. 3C shows a downward finger sweeping motion represented by a downward arrow on the touch panel 110. In contrast to the upward finger sweeping motion as shown in FIG. 3A, the downward finger sweeping motion may correlate to a decrease in volume in the electronic device. The extent of the decrease in volume may be controlled by how far the finger moves downwardly along the touch panel 110. The further the finger moves downwardly along the touch panel 110, the higher the decrease in volume. The downward finger sweeping motion may start at any position on the touch panel 110 as long as there may be sufficient space to move downwardly. Should the downward finger sweeping motion starts at a position towards the lower end of the touch panel 110, the user may then repeat this downward finger sweeping motion so as to obtain the desired decrease in volume. Further, the downward finger sweeping motion may not necessarily be in a vertical downward direction substantially along a fixed X-co-ordinate. The downward finger sweeping motion may also be at an angle or any other pattern as long as the downward finger sweeping motion may be directed downwards (or the X-co-ordinate and the Y-co-ordinate may be decreasing).

FIGS. 4A to 4C show different examples of how a user can carry or wear a controller arrangement 102 according to an embodiment.

The controller arrangement 102 may be positioned at any suitable position on a clothing (for example shirt, dress, skirt, pant, short) or an accessory (for example belt, watch, hair-band, tie) worn by the user or even placed directly on the user as long as the controller arrangement 102 may not be highly visible to any external party.

Further, the controller arrangement 102 may include at least one attachment member (not shown) configured for attachment to the user's clothing or accessory. The at least one attachment member may be in the form of spring clips, annual clamp, for example as long as the controller arrangement 102 may hold on to the clothing or accessory and yet able to communicate remotely with an electronic device. The number and position of the at least one attachment member on the support substrate 104 may vary depending on user and design requirement.

As an example, FIG. 4A shows that the controller arrangement 102 may be attached or clipped on a collar of a shirt 112 worn by the user such that the controller arrangement 102 may be virtually invincible.

As an alternative example, FIG. 4B shows that the controller arrangement 102 may be attached or clipped under the overlapping portions of a shirt 112 so that the controller arrangement 102 may not be easily seen from the outside.

As another example, FIG. 4C shows that the controller arrangement 102 may be attached or clipped onto a sleeve of a T-shirt 114 worn by the user.

The embodiments as shown in FIGS. 4A to 4C are merely examples of some possible position of the controller arrangement 102 on the clothing worn by the user. The position of the controller arrangement 102 ‘may vary according to the needs and desire of the user.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1-16. (canceled)

17. A controller configuration configured to remotely control an electronic device, the controller configuration comprising:
a support substrate;
a driver configured to drive the controller configuration;
an antenna configured to allow the controller configuration to communicate with the electronic device;
a touch panel configured to allow tracking of a finger movement based on a resistance change;
a processor configured to generate a corresponding control signal based on tracking of the finger movement so as to remotely control the electronic device; and
wherein said driver, said antenna, said touch panel and said processor are monolithically integrated in or on said support substrate.

18. The controller configuration according to claim 17, wherein said support substrate has a flexible printed circuit board.

19. The controller configuration according to claim 17, wherein said driver includes a battery or an energy buffer driven by an external driving source.

20. The controller configuration according to claim 19, wherein said battery has a rechargeable micro battery.

21. The controller configuration according to claim 19, wherein said energy buffer has a supercapacitor.

22. The controller configuration according to claim 19, wherein said energy buffer is driven by the external driving source via a direct energy transfer or a remote energy transfer.

23. The controller configuration according to claim 22, wherein the direct energy transfer includes a wired connection.

24. The controller configuration according to claim 22, wherein the remote energy transfer includes inductive coupling.

25. The controller configuration according to claim 17, wherein said antenna is printed directly on said support substrate.

26. The controller configuration according to claim 17, wherein said touch panel is configured to include a set of two-dimensional coordinates to allow tracking of the finger movement.

27. The controller configuration according to claim 17, wherein the finger movement is selected from a group consisting of an upward finger sweeping motion, a downward finger sweeping motion and a tapping finger motion.

28. The controller configuration according to claim 17, wherein the controller configuration is dimensioned to have a thickness of about 1 mm or less.

29. The controller configuration according to claim 17, further comprising at least one attachment member configured for attachment to a user.

30. An electronic system, comprising:
an electronic device; and
a controller configuration configured to remotely control said electronic device, said controller configuration containing:
a support substrate;
a driver configured to drive said controller configuration;
an antenna configured to allow said controller configuration to communicate with said electronic device;
a touch panel configured to allow tracking of a finger movement based on a resistance change;
a processor configured to generate a corresponding control signal based on tracking of the finger movement so as to remotely control said electronic device; and
said driver, said antenna, said touch panel and said processor are monolithically integrated in or on said support substrate.

31. The electronic system according to claim 30, wherein said controller configuration is configured to remotely control said electronic device via a wireless communication selected from the group consisting of radio frequency communication, microwave communication, bluetooth communication and infrared short range communication.

32. The electronic system according to claim 30, wherein said electronic device has a hearing aid or a communication device.
